(19) United States
(12) Patent Application Publication
(10) Pub. No.: US 2003/0101969 A1
(43) Pub. Date: Jun. 5, 2003

(54) Clamping element for a fuel injection valve and fuel injection system

(76) Inventors: Albrecht Baessler, Korntal-Muenchingen (DE); Thomas Fuerst, Schwieberdingen (DE)

Correspondence Address: KENYON & KENYON, ONE BROADWAY, NEW YORK, NY, 10004, US

(21) Appl. No.: 10/129,165

(22) PCT Filed: Aug. 25, 2001
(86) PCT No.: PCT/DE01/03260

(30) Foreign Application Priority Data
Sep. 1, 2000 (DE) 100 34 084.8

(51) Int. Cl. F02M 55/02

(52) U.S. Cl. 123/468; 123/470

(57) ABSTRACT

A clamping element for a fuel injector (18) that is insertable into a mounting hole of a cylinder head (26) of an internal combustion engine and directly injects fuel into a combustion chamber of the internal combustion engine has a first step ring (19). This at least partially surrounds the fuel injector (18) and has a valve pressure surface (20) that may rest on the fuel injector (18). The first step ring (19) has at least one circumferential slope surface (21) on its side facing away from the valve pressure surface (20), which engages with a corresponding circumferential slope surface (24) of a second step ring (22), which has a counterpressure surface (23). The slope surfaces (21, 24) are arranged so that the first step ring (19) and the second step ring (22) are pressed axially apart when they are rotated relatively to one another.

### BACKGROUND INFORMATION

The present invention relates to a clamping element according to the definition of the species of claim 1 and a fuel injection system according to the definition of the species of claim 11.

A clamping element in the form of a hold-down element is known from Japanese Laid-Open Document 08-312503 A. The hold-down element holds down a fuel injector against a relatively high combustion pressure prevailing in the combustion chamber of the internal combustion engine. Herein, the hold-down element engages with a collar of the fuel injector at two circumferentially opposite locations, the collar resting with its lower side on the upper side of the cylinder head, so that the fuel injector is held down. Herein, the hold-down element is pulled on to the cylinder head by a clamping screw.

The hold-down element that is known heretofore per Japanese Laid-Open Document 08-312503 A has the disadvantage that it is difficult to access the clamping screw if a fuel distribution line has already been fitted. If the fuel distribution line is not fitted until after the hold-down elements have been fitted and after they have been pre-tensioned to the defined retention force, the fuel injectors can no longer be moved or can only be moved if considerable force is applied, and tolerances at the connection points to the fuel distribution line, which in the case of high-pressure injection systems is rigid, cannot be modified. Furthermore, a tight connection can only be achieved with difficulty or not at all. If the clamping screws are not tightened until after the fuel distribution line has been fitted, it is difficult to access the clamping screws.

Furthermore, a hold-down device embodied as a clamp bracket similar to the known hold-down element from Japanese Laid-Open Document 08-312503 A, is known from German Patent Application 197 35 665 A1. In the case of the hold-down device, the cylinder head has a recess in which the collar of the fuel injector is arranged, so that the collar of the fuel injector on which the hold-down device acts is lowered into the cylinder head. This has the disadvantages already mentioned.

A clamping element which holds a fuel injector in a mounting hole of a cylinder head of an internal combustion engine and rests against a fuel distribution line, is known from German Patent Application 197 56 102 A1. The clamping element includes a spiral spring that extends between a spring holding element of the fuel injector and a spring holding element of the fuel distribution line. Furthermore, from German Patent Application 197 56 102 A1, it is known that for assembly one or more assembly clamps, which pre-tension the fuel injector, the fuel distribution line and the spiral springs and hold them in their position until assembly has been completed, must be provided.

The disadvantage of the clamping element that is known from German Patent Application 197 56 102 A1 is that with a spiral spring it is difficult to achieve the necessary high clamping forces. Furthermore, it is disadvantageous that if a premounted unit that includes a fuel distribution line, clamping elements and fuel injectors is fitted, additional assembly clamps are required. Moreover, it is disadvantageous that when the fuel distribution line is fitted all spiral springs must be tensioned simultaneously and adjustments of individual fuel injectors to any tolerances in the mounting hole in question are not carried out consecutively.

### ADVANTAGES OF THE INVENTION

By contrast, the clamping element according to the present invention having the features of claim 1 has the advantage that high clamping forces may be achieved, and these high clamping forces may be achieved using small clamping element dimensions.

Advantageous further refinements of the clamping element indicated in claim 1 may be achieved via the measures set forth in claims 2 to 9.

It is advantageous if the first step ring and the second step ring have coaxial holes into which the fuel injector and a connection piece of a fuel distribution line may be inserted. This means small design dimensions and a favorable arrangement of the clamping element may be achieved, because only one circumferential collar around the fuel injector is required to bear the clamping force. Furthermore, it is advantageous that the clamping element is able to be held in the holes.

It is advantageous if the first step ring and the second step ring are held so that they are concentric relative to one another by shoulder of the first step ring or second step ring which engages with a corresponding step of an axial hole of the other step ring. As a result, the clamping element may be designed as a compact, self-contained component that may be inserted as a single element during assembly.

It is advantageous if the first step ring and the second step ring each have on their circumference a bolt that is rotatably mounted axially parallel to the step ring and is axially movable, and have a hole that extends across it, and if the hole of one bolt is a threaded hole, and if a screw that is held in the hole of the other bolt is present and engages with the threaded hole. Thus the first and second step ring are able to be rotated against one another and the clamping force of the clamping element may be adjusted. In particular, the screw may be arranged so that it is easily accessible, as the axis of the screw points away from a plane that is at least approximately formed by the fuel injectors and the fuel distribution line and does not lie in that plane.

The fuel injection system according to the present invention having the features of claim 11 has the advantage relative to the related art described above that the retention force is imparted against the fuel distribution line. As a result, no additional components are required, which advantageously saves space. Moreover, the sequence of tensioning may be chosen freely.

### BRIEF DESCRIPTION OF THE DRAWING

A related-art clamping element and an exemplary embodiment of the present invention are shown in a simplified form in the drawing and described in greater detail in the description below.

FIG. 1 shows a related-art clamping element via which a fuel injector is clamped into a mounting hole;

FIG. 2 shows a clamping element according to the present invention, installed between a fuel distribution line (only partly shown) and a fuel injector (only partly shown);

FIG. 3 shows a section through the clamping element according to the present invention shown in FIG. 2, with fuel distribution line (part of which is shown in a sectional view);

FIG. 4 shows the detail section IV as shown in FIG. 3;

FIG. 5 shows a top view of the section plane shown as V in FIG. 2, with a tensioning device formed by a screw; and

FIG. 6 shows the clamping element according to the present invention installed between a fuel distribution line (only partly shown) and a fuel injector (only partly shown), shown in a side view that has been rotated by 90° relative to FIG. 2.

### DETAILED DESCRIPTION OF THE EMBODIMENT

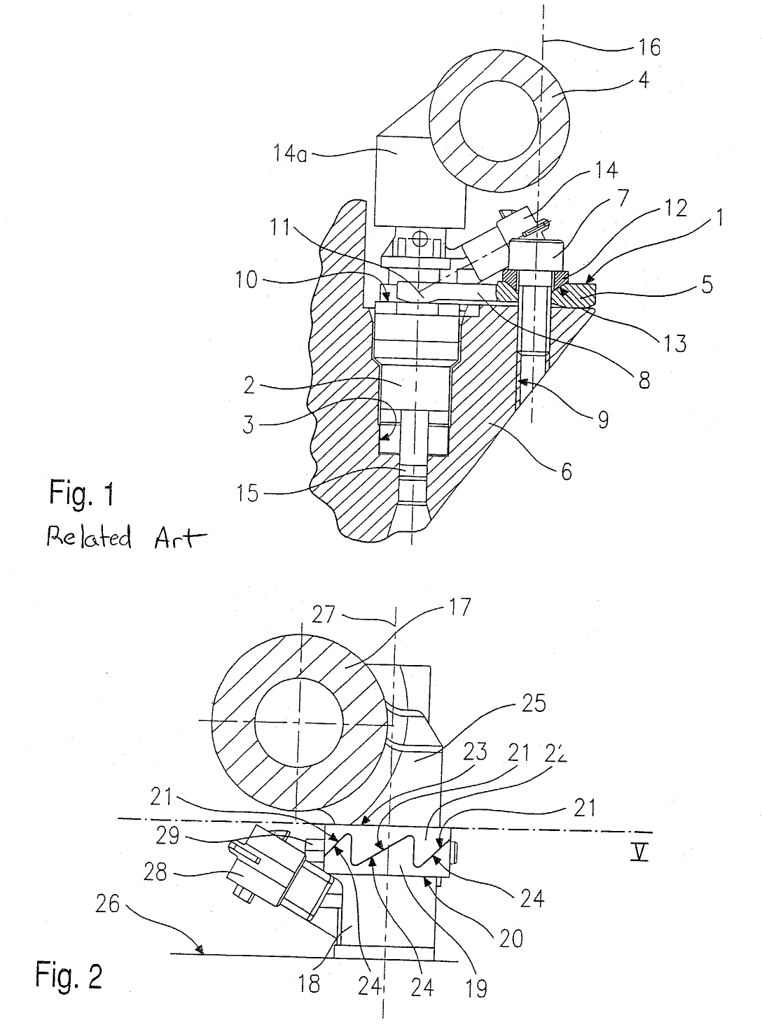

FIG. 1 shows a related-art clamping element.

The clamping element is in the form of a hold-down element 1, which holds a fuel injector 2 in a mounting hole 3. Fuel injector 2 is connected to a rigid fuel distribution line 4, as is customary in the case of fuel injectors that inject fuel at high pressure into the combustion chamber. Hold-down element 2 has a contact piece 5, which rests on a cylinder head 6 (shown here in section view, and only partly shown) and has an attachment element that is embodied as screw 7. Screw 7 penetrates a lever arm 8 of hold-down element 1 and is screwed into a threaded hole 9 of cylinder head 6.

Lever arm 8 divides in the shape of a fork around fuel injector 2. Fuel injector 2 has a step 10, on whose radial surface pressure mushrooms 11, which are formed on the ends of the fork-shaped section of lever arm 8 of hold-down element 1, rest. If it is rotated deeper into threaded hole 9, screw 7 pulls lever arm 8, which rests against cylinder head 6 via contact piece 5, toward cylinder head 6 via a washer 12, which allows angle compensation via a spherical surface 13. As a result, at the fork-shaped end of lever arm 8 a clamping force is exerted on fuel injector 2 in the direction of mounting hole 3 via pressure mushrooms 11 (only one can be seen in the chosen view in the drawing) at two points of step 10 that are located opposite one another on the circumference of fuel injector 2. This clamping force holds fuel injector 2 in mounting hole 3 against the combustion pressure in the combustion chamber (not shown). FIG. 1 also shows connector plug 14 for triggering fuel injector 2 and seal 15 opposite the combustion chamber. Fuel distribution line 4 is connected to fuel injector 2 via connector nozzle 14a.

As a general rule, there is little space, particularly next to and above the cylinder head, as it is desirable for the design of the internal combustion engine to be compact. As a result, fuel distribution line 4 is arranged as directly as possible above fuel injectors 2 and is generally offset somewhat from the middle of the cylinder head. This results in the arrangement shown here, in which the extension of central axis 16 of screw 7 intersects with fuel distribution line 4. As a result, once fuel distribution line 4 has been installed it is only possible to introduce a tool laterally and with freedom of movement in one plane, and often this is hindered by other components, particularly the ignition or gas exchange system.

FIG. 2 shows a clamping element according to the present invention that is arranged between a fuel distribution line 17 (only partly shown) and a fuel injector 18 (only partly shown), which is inserted into a cylinder head 26. A first step ring 19 has a valve pressure surface 20, which rests indirectly against fuel injector 18. On the side facing away from fuel injector 18 and valve pressure surface 20, first step ring 19 has a plurality of circumferential slope surfaces 21, which in this case are arranged in one direction circumferentially, have the same incline, and each form a section of a screw surface.

A second step ring 22 has a counterpressure surface 23, which rests against a shoulder of fuel distribution line 17. On the side facing fuel injector 18, second step ring 22 also has a plurality of circumferential slope surfaces. Counterpressure surface 23 rests against a connection piece 25 of fuel distribution line 17. Furthermore, a central axis 27, which corresponds to the axis of the mounting hole (not shown) of fuel injector 18 in cylinder head 26, is also shown in the drawing. Circumferential slope surfaces 21, 24 of first step ring 19 and of second step ring 22 match one another in their incline and orientation of rotation so that they work together as a thread and, respectively, engage with one another via their slope surfaces 21, 24. Incline surfaces 21, 24 are designed for example to resemble the teeth of a saw.

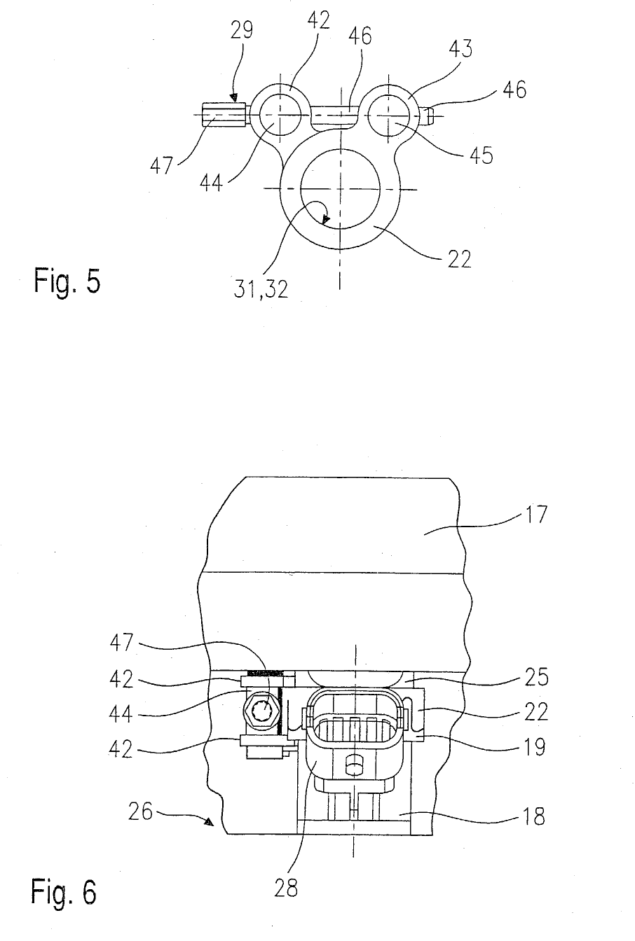

FIG. 2 also shows a connector plug 28 of fuel injector 18, which in the embodiment shown here is a fuel injector 18 having an electrically triggered actuator. Furthermore, the figure shows parts of a tensioning device 29 (largely hidden) which allows first step ring 19 and second step ring 22 to be rotated relative to one another and which is described in detail in FIG. 5 below.

In the non-tensioned state shown here, individual circumferential slope surfaces 21 of first step ring 19 are in contact with the corresponding circumferential slope surfaces of second step ring 22 so that every circumferential slope surface 21, 24 is in contact with a corresponding circumferential slope surface 21, 24 over its entire surface. If first step ring 19 and second step ring 22 are rotated relative to one another, circumferential slope surfaces 21, 24 slide against each other and push first step ring 19 and second step ring 22 apart. Valve pressure surface 20 and counterpressure surface 23 move in the axial direction relative to central axis 27.

If valve pressure surface 20 rests on fuel injector 18 and counterpressure surface 23 rests on connection piece 25 of fuel distribution line 17, the clamping element presses fuel injector 18 into mounting hole of cylinder head 26, and herein rests against fuel distribution line 17. If the incline of the circumferential slope surfaces 21, 24 is chosen appropriately, the compressive force exerted may be determined as a function of the force with which first step ring 19 and second step ring 22 are rotated relative to one another. In particular, substantial compressive forces may be achieved.

The maximum distance in the axial direction relative to central axis 27 by which first step ring 19 and second step ring 22 may be pressed apart is determined by the number of circumferential slope surfaces 21, 24 and the incline. Thus it is possible to offset substantial tolerances in the axial direction relative to central axis 27 that arise between fuel distribution line 17 and fuel injector 18. Furthermore, the clamping element does not require any further attachment point on cylinder head 26, like screw 7 in FIG. 1 in the case of the known hold-down element. Altogether, the dimensions of the clamping element according to the present invention are advantageously small.

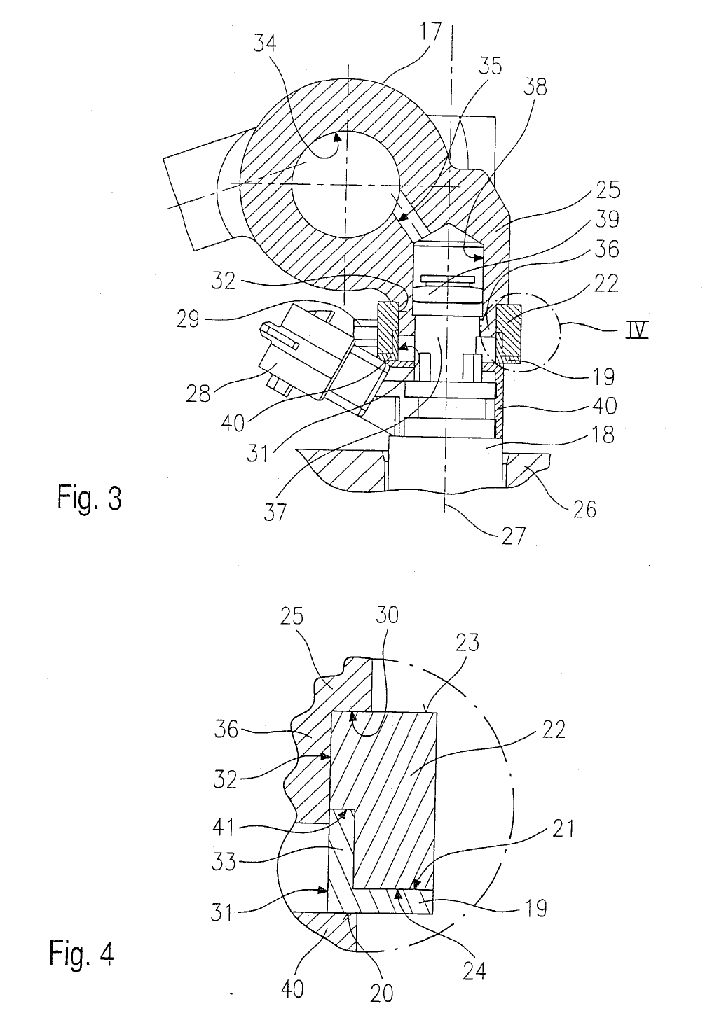

FIG. 3 shows the clamping element according to the present invention shown in FIG. 2, but in a sectional view, fuel distribution line 17 being partially shown in a sectional view. In FIG. 3, the same reference numbers are used as in FIG. 2 for the same elements. Fuel injector 18, which is inserted into cylinder head 26, is also only partly shown. Connection piece 25 of fuel distribution line 17 is connected via an inflow hole 35 to a distribution pipe 34 of fuel distribution line 17. Central axis 27, which is shown in the drawing, corresponds to the axis of the mounting hole (not shown) of fuel injector 18 in cylinder head 26.

Moreover, connection piece 25 has a smaller-diameter shoulder 36, which is held in a coaxial hole 31 of first step ring 19 and in a coaxial hole 32 of second step ring 22, which have the same diameter. Thus the clamping element is defined radially relative to central axis 27 with regard to connection piece 25 of fuel distribution line 17.

Fuel injector 18 is inserted into a hole 38 of connection piece 25 of fuel distribution line 17 via an inflow section 37. A ring seal 39 seals inflow section 37 of fuel injector 18 against hole 38 of connection piece 25. Fuel injector 18 has a clamping sleeve 40 (shown in a sectional view), on which first step ring 19 rests and which has a recess, e.g., in the area of connector plug 28. This clamping sleeve 40 may also be designed so that it and fuel injector 18 are a single component. FIG. 2 also shows connector plug 28 of fuel injector 18, which in the embodiment shown here is a fuel injector 18 having an electrically triggered actuator, and also partially shows tensioning device 29, which is explained in detail in FIG. 5 below.

FIG. 4 shows detail section IV from FIG. 3. First step ring 19 rests against clamping sleeve 40 of fuel injector 18 via valve pressure surface 20. Second step ring 22 rests on a shoulder 30 of connection piece 25 of fuel distribution line 17 via counterpressure surface 23. Circumferential slope surface 21 of first step ring 19 and circumferential slope surface 24 of second step ring 22 are formed so that radially inward they do not reach coaxial hole 31 of first step ring 19 and coaxial hole 32 of second step ring 22. First step ring 19 has a shoulder 33, which is held in a step 41 of coaxial hole 32 of second step ring 22.

Thanks to this embodiment of the clamping element, fuel injector 18 and connection piece 25 of fuel distribution line 17 may be inserted into one another. The seal created by ring seal 39 may be checked when a pre-mounted unit that includes fuel injector 18, the clamping element and fuel distribution line 17 is produced, because in the non-tensioned state the clamping element according to the present invention does not exert any force on fuel injector 18 and fuel distribution line 17, and therefore the components remain in the position relative to one another that they were in when checked. Furthermore, the clamping element according to the present invention advantageously has small dimensions and is held by concentric holes 31, 32 and smaller-diameter shoulder 36 of connection piece 25. Moreover, shoulder 33 of first step ring 19, which is held in step 41 of coaxial hole 32 of second step ring 22, ensures that circumferential slope surfaces 21, 24 are unable to move radially relative to one another.

FIG. 5 shows a top view of second step ring 22, this being a top view of section plane V in FIG. 2. For the sake of simplicity, the parts of fuel injector 18 and connection piece 25 of fuel injection line 17 that are located inside coaxial holes 31, 32 of first step ring 19 and of second step ring 22 are not shown. In FIG. 5, first step ring 19 is hidden by second step ring 22. Tensioning device 29 includes a first double eye 42, which is attached to first step ring 19, and second double eye 43, which is attached to second step ring 22. A first bolt 44 is rotatably and axially movably mounted in first double eye 42. Correspondingly, a second bolt 45 is rotatably and axially movably mounted in second double eye 43. Second bolt 45 has a threaded hole into which a screw 46 is inserted so that it extends transversely. Screw 46 is held in a hole of first bolt 44 and rests against first bolt 44 via a screw head 47.

If this screw is rotated into the threaded hole of second bolt 45, screw head 47 pulls second bolt 45 in the direction of first bolt 44. First step ring 19 and second step ring 22 are rotated relative to one another via first double eye 42 and second double eye 43 and the clamping element is tensioned. As first step ring 19 and second step ring 22 move apart in the direction of the axes of bolts 44, 45, there would be a tendency for screw 46 to tilt in the threaded hole of second bolt 45 and the hole of first bolt 44. To avoid this, bolts 44, 45 are axially movable, and therefore may compensate for the movement apart of first step ring 19 and second step ring 22.

FIG. 6 shows the clamping element according to the present invention, installed between a fuel distribution line 17 (only partly shown) and a fuel injector 18 (only partly shown) in a side view that has been rotated by 90° relative to the side view in FIG. 2. The same reference numbers have been used for the same components.

The view shows fuel injector 18 having connector plug 28 and cylinder head 26. First step ring 19 and second step ring 22 are located between connection piece 25 of fuel distribution line 17 and fuel injector 18. First bolt 44 is held in first double eye 42, which is connected to first step ring 19. Screw head 47 rests against this first bolt 44. First bolt 44 may be moved in the direction of its axis in first double eye 42.

Screw head 47 is easily accessible with a tool, because, as shown in FIG. 6, it may be arranged so that it points away from the internal combustion engine. It is then easy to reach, as screw head 47 is not covered by other components and is reachable with an appropriate tool.

What is claimed is:

1. A clamping element for a fuel injector (18) that is insertable into a mounting hole of a cylinder head (26) of an internal combustion engine and directly injects fuel into a combustion chamber of the internal combustion engine, having a first step ring (19) that at least partially surrounds the fuel injector (18) and may rest on the fuel injector (18) via a valve pressure surface (20), wherein, on its side facing away from the valve pressure surface (20), the first step ring (19) has at least one circumferential slope surface (21), which engages with a corresponding circumferential slope surface (24) of a second step ring (22), which has a counterpressure surface (23); and the slope surfaces (21, 24) are arranged so that the first step ring (19) and the second step ring (22) are pressed axially apart when they are rotated relatively to one another.

2. The clamping element according to claim 1, wherein the first step ring (19) and the second step ring (22) have coaxial holes (31, 32) into which the fuel injector (18) and a connection piece (25) of a fuel distribution line (17) may be inserted.

3. The clamping element according to claim 2, wherein the first step ring (19) and/or second step ring (22) is/are held in the coaxial holes (31, 32) by a smaller-diameter shoulder (36) of the connection piece (25) of the fuel distribution line (17).

4. The clamping element according to one of claims 1 to 3, wherein the first step ring (19) and the second step ring (22) are held concentrically with respect to each other by a shoulder (33) of the first step ring (19) or second step ring (22), the shoulder engaging with a corresponding step (41) of an axial hole (32) of the other step ring (22).

5. The clamping element according to one of claims 1 to 3, wherein the first step ring (19) and the second step ring (22) are held concentrically relative to one another by a sleeve which is situated in a common axial hole of the first step ring (19) and second step ring (22).

6. The clamping element according to one of claims 1 to 5, wherein the first step ring (19) and the second step ring (22) each have a tensioning element on their circumference, and a tensioning device (29) is provided between these two tensioning elements, the first step ring (19) and the second step ring (22) being axially pressed apart if these tensioning elements are pulled toward one another.

7. The clamping element according to claim 6, wherein the tensioning element of each step ring (19, 22) includes a bolt (44, 45), which is rotationally mounted so that its axis is parallel to that of the step ring (19, 22), and is axially movable, and each bolt (44, 45) is penetrated by a transverse hole.

8. The clamping element according to claim 7, wherein the hole of one bolt (45) is a threaded hole, and the tensioning device is a screw (46) that is held in the hole of the other bolt (44) and engages with the threaded hole.

9. The clamping element according to claim 8, wherein the tensioning device is positioned on the circumference of the first step ring (19) and the second step ring (22) so that one axis of the screw (46) is approximately perpendicular to a plane, which is defined at least approximately by a rigid fuel distribution line (17), along its longitudinal extension, and by the fuel injector (18) connected to it.

10. The clamping element according to one of the preceding claims, wherein the slope surfaces (21, 24) of the step rings (19, 22) are designed so as to resemble the teeth of a saw.

11. A fuel injection system having a fuel distribution line (17), having fuel injectors (18) for directly injecting fuel into combustion chambers of an internal combustion engine, which are connected to the fuel distribution line (17) via connection nozzles (25) and are insertable into mounting holes of a cylinder head (26) of an internal combustion engine, and having clamping elements, which at least partially surround the fuel injectors (18) and have a first step ring (19) that rests against the fuel injector (18) via a valve pressure surface (20), wherein, on its side facing away from the valve pressure surface (20), the first step ring (19) has at least one circumferential slope surface (21), which engages with a corresponding circumferential slope surface (24) of a second step ring (22), which rests against the assigned connection nozzle (25) of the fuel distribution line (17) via a counterpressure surface (23); and the slope surfaces (21, 24) are arranged so that the first step ring (19) and the second step ring (22) are pressed axially apart when they are rotated relatively to one another.
